(19) United States
(12) Patent Application Publication
(10) Pub. No.: US 2008/0067003 A1
(43) Pub. Date: Mar. 20, 2008

(54) STEP-STOOL ASSEMBLIES WITH CONTINUOUS OUTER SHELLS AND RELATED METHODS

(76) Inventors: Mark B. Emge, Lawrence, KS (US); Mario Gonzalez, Lawrence, KS (US)

Correspondence Address: SCHWEGMAN, LUNDBERG & WOESSNER, P.A., P.O. BOX 2938, MINNEAPOLIS, MN, 55402, US

(21) Appl. No.: 11/855,659

(22) Filed: Sep. 14, 2007

Related U.S. Application Data
(60) Provisional application No. 60/825,830, filed on Sep. 15, 2006.

(51) Int. Cl. E06C 7/16; B62B 3/00; F16M 11/00

(52) U.S. Cl. 182/222; 248/158; 280/32.5

(57) ABSTRACT

Step-stool assemblies and related methods are described. A step-stool assembly comprises an inner base frame and a continuous outer shell. The inner base frame includes a first loadable surface near a top thereof. The outer shell unitarily extends from an upper portion to a lower portion. The lower portion includes a size and shape disposable around, and attachable with, an outer perimeter of the inner base frame. The upper portion is configured to extend above the first loadable surface of the base frame and includes a second loadable surface. The outer shell includes at least one foot-receiving aperture to provide access to the first loadable surface when the outer shell and inner base frame are attached. In an example, a perimeter of the shell lower portion is greater than the base frame outer perimeter, while a perimeter of the shell upper portion is less than the base frame outer perimeter.

### PRIORITY OF INVENTION

This non-provisional application claims the benefit of priority under 35 U.S.C. §119(e) to U.S. Provisional Patent Application Ser. No. 60/825,830, filed on Sep. 15, 2006, which is herein incorporated by reference in its entirety.

### TECHNICAL FIELD

This patent document pertains generally to articles of furniture. More particularly, but not by way of limitation, this patent document pertains to step-stool assemblies with continuous outer shells and related methods.

### BACKGROUND

Step-stool assemblies of the short rise type, such as those with two or three steps, have been found useful when working with objects in relatively high and low locations. As an example, when working with objects at relatively high locations (e.g., upper-shelf items), step-stool assemblies can provide the additional extension needed for a user to reach such objects. As another example, when working with objects at relatively low locations (e.g., lower-shelf items), step-stool assemblies can provide a comfortable seat when searching and dealing with such objects.

### OVERVIEW

The present inventors have recognized, among other things, that existing step-stool assemblies are unnecessarily bulky and heavy, can be difficult to assemble and disassemble, and limited in available manufacturing techniques. The present inventors further believe that existing step-stool assembly configurations may not be the most efficient in terms of support provided versus assembly size and weight due to design discontinuities.

This patent document describes various step-stool assemblies including an inner base frame and a continuous outer shell. The inner base frame includes a first loadable surface near a top portion thereof. The outer shell continuously extends from an upper portion to a lower portion. The lower portion includes a size and shape disposable around, and attachable with, an outer perimeter portion of the inner base frame. The upper portion is configured to extend above the first loadable surface of the base frame and includes a second loadable surface. The outer shell includes at least one foot-receiving aperture to provide access to the first loadable surface when the outer shell and inner base frame are in attached form. In an example, a perimeter of the shell lower portion is greater than the base frame outer perimeter and tapers to a perimeter at the shell upper portion, which is less than the base frame outer perimeter.

In Example 1, a step-stool assembly comprises an inner base frame having a first loadable surface near a top portion thereof; and a continuous outer shell having an upper portion and a lower portion, the lower portion having a size and shape disposable around, and attachable with, an outer perimeter of the inner base frame, the upper portion extending above the first loadable surface and including a second loadable surface, and configured such that the first loadable surface is accessible via at least one foot-receiving aperture in the outer shell when the inner base frame is attached with the outer shell.

In Example 2, the step-stool assembly of Example 1 is optionally configured such that a perimeter of the lower portion of the outer shell is greater than the outer perimeter of the inner base frame, and a perimeter of the upper portion of the outer shell is less than the outer perimeter of the inner base frame.

In Example 3, the step-stool assembly of at least one of Examples 1-2 is optionally configured such that the first loadable surface is exposed substantially in its entirety via the at least one foot-receiving aperture.

In Example 4, the step-stool assembly of at least one of Examples 1-3 is optionally configured such that the upper portion of the outer shell includes one or more substantially vertical arm members, the arm members linking the second loadable surface and the lower portion of the outer shell.

In Example 5, the step-stool assembly of at least one of Examples 1-4 optionally comprises a stop member provided on an inner surface of the outer shell, a portion of the stop member contacting the inner base frame when the outer shell is attached therewith.

In Example 6, the step-stool assembly of at least one of Examples 1-5 optionally comprises one or more retractable roller units, each roller unit coupled with a portion of the inner base frame and providing rollable support to no-load conditions and collapsible under application of load to the first or second loadable surfaces.

In Example 7, the step-stool assembly of Example 6 is optionally configured such that a stem portion of the one or more retractable roller units is configured to retract within an inner base frame socket under application of the load.

In Example 8, the step-stool assembly of at least one of Examples 1-7 optionally comprises one or more non-slip members disposed on at least one of the first or second loadable surfaces.

In Example 9, the step-stool assembly of at least one of Examples 1-8 optionally comprises a floor engaging member disposed around a perimeter of the lower portion of the outer shell.

In Example 10, the step-stool assembly of at least one of Examples 1-9 is optionally configured such that the inner base frame and the outer shell are attachable with one another using one or more complementary locking elements.

In Example 11, the step-stool assembly of any of Examples 1-10 is optionally configured such that the first loadable surface is exposed from a plurality of directions via the at least one foot-receiving aperture.

In Example 12, the step-stool assembly of at least one of Examples 1-11 is optionally configured such that the inner base frame is substantially hollow with leg members depending from the first loadable surface and having a lower rim connecting the leg members.

In Example 13, the step-stool assembly of at least one of Examples 1-12 is optionally configured such that at least one of the first or second loadable surfaces includes a plurality of ribs configured to support a load.

In Example 14, a method comprises moving a step-stool assembly to a desired location; contacting at least one of a first loadable surface of an inner base frame or a second loadable surface of an outer shell, the outer shell unitarily extending from an upper portion including the second loadable surface to a lower portion disposable around the inner base frame, and including at least one foot-receiving aperture providing access to the first loadable surface; and applying a downward load to at least one of the first or second loadable surfaces, including retracting one or more roller units and contacting a floor engaging member disposed around the lower portion of the outer shell with a floor surface.

In Example 15, the method of Example 14 optionally comprises attaching the outer shell with the inner base frame via, at least in part, interlocking slots and ridges on opposing inner base frame and outer shell surfaces.

In Example 16, the method of at least one of Examples 14-15 optionally comprising readily separating the outer shell and the inner base frame for independent use thereof.

In Example 17, the method of at least one of Examples 14-16 is optionally configured such that contacting the first loadable surface includes intersecting two arm members linking the upper and lower portions of the outer shell.

In Example 18, a method comprises forming a first loadable surface and a second loadable surface at different height elevations, including forming an inner base frame having the first loadable surface near a top portion thereof, and forming an outer shell continuously extending from an upper portion to a lower portion, the second loadable surface disposed at the upper portion and the lower portion disposable around the inner base frame; and detachably nesting the inner base frame within the periphery of the outer shell.

In Example 19, the method of Example 18 is optionally configured such that forming the lower portion of the outer shell includes forming at least one side wall depending from an end of an arm member linking the upper and lower shell portions.

In Example 20, the method of at least one of Examples 18-19 is optionally configured such that forming the lower portion of the outer shell includes forming a shell perimeter greater than an outer perimeter of the inner base frame.

In Example 21, the method of at least one of Examples 18-20 optionally comprises disposing a coil spring within a socket of the inner frame member, the coil spring configured to rest against a closed end of the socket on a first end and engage with a wheel member on a second end.

In Example 22, the method of at least one of Examples 18-21 optionally comprises disposing a resilient floor engaging member around the lower portion of the outer shell.

In Example 23, the method of at least one of Examples 18-22 is optionally configured such that detachably nesting the inner base frame within the outer shell includes abutting a stop member protruding from an inner surface of the outer shell against a portion of the first loadable surface.

In Example 24, the method of at least one of Examples 18-23 is optionally configured such that detachably nesting the inner base frame within the periphery of the outer shell includes interlocking elements disposed on base frame and outer shell opposing surfaces.

In Example 25, the method of at least one of Examples 18-24 is optionally configured such that forming at least one of the inner base frame or the outer shell includes molding a polymer resin material.

Advantageously, the present step-stool assemblies can be sturdy in construction, relatively lightweight, economical to manufacture (e.g., open to economical molding techniques), simple to assemble and disassemble—in some examples without the use of tools, sleek and compact, and well adapted to many types of consumer or commercial uses. In addition, the present step-stool assemblies are believed to provide greater support strength per unit of weight, as fewer discontinuities in the assembly design are present. These and other examples, advantages, and features of the present assemblies and methods will be set forth in part in the following Detailed Description. This Overview is intended to provide an overview of subject matter of the present patent document. It is not intended to provide an exclusive or exhaustive explanation of the invention. The Detailed Description is included to provide further information about the present patent document.

### BRIEF DESCRIPTION OF THE DRAWINGS

In the drawings, like numerals describe similar components throughout the several views. Like numerals having different letter suffixes represent different instances of similar components. The drawings illustrate generally, by way of example, but not by way of limitation, various embodiments discussed in the present document.

FIG. 1 is an isometric view of a step-stool assembly in detached form, the step-stool assembly including an inner base frame and a continuous outer shell.

FIG. 2 is an isomeric view of a step-stool assembly in attached form, the step-stool assembly including an inner base frame and a continuous outer shell.

FIG. 3 is a top view of a step-stool assembly, the step-stool assembly including an inner base frame and a continuous outer shell.

FIG. 4 is a bottom view of a step-stool assembly, the step-stool assembly including an inner base frame and a continuous outer shell.

FIG. 5 is a cross-sectional view of a portion of a step-stool assembly, such as along line 5-5 of FIG. 2, the step-stool assembly including an inner base frame and a continuous outer shell.

FIG. 6 illustrates a gliding member for optional use with a step-stool assembly, the step-stool assembly including an inner base frame and a continuous outer shell.

FIG. 7 is an isometric view of another step-stool assembly in detached form, the step-stool assembly including an inner base frame and a continuous outer shell.

FIG. 8 is a block diagram of an example method of using a step-stool assembly, the step-stool assembly including an inner base frame and a continuous outer shell.

FIG. 9 is a block diagram of an example method of manufacturing a step-stool assembly, the step-stool assembly including an inner base frame and a continuous outer shell.

### DETAILED DESCRIPTION

Existing step-stool assemblies typically have many drawbacks including being difficult to assemble and disassemble, being limited in available manufacturing techniques, and being heavy or bulky. Recognizing these drawbacks, among others, the present inventors have conceived of step-stool assemblies sturdy in construction, simple to assemble and disassemble—in some examples, without the need for tools, economical to manufacture, and attractively sleek and compact. It is believed the step-stool assemblies described herein will find use in many areas of the consumer and commercial markets, such as from kitchens to bathrooms, to garages, to storerooms.

### EXAMPLES

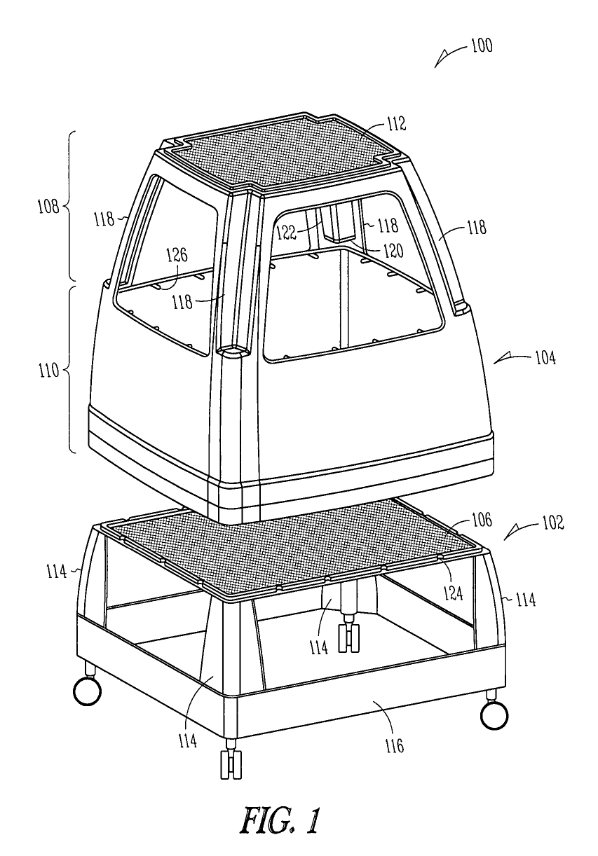

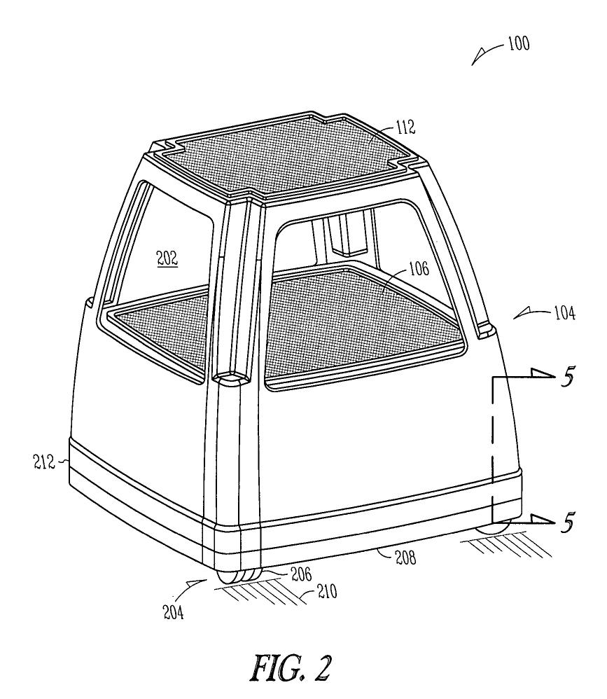

FIG. 1 is an isometric view of a step-stool assembly 100 in detached form. Among other things, the step-stool assembly 100 includes an inner base frame 102 and a continuous outer shell 104. The inner base frame 102 includes a first loadable surface 106 near a top portion thereof. In the example shown, the inner base frame 102 is substantially hollow with leg members 114 depending from the first loadable surface 106 and having a lower rim 116 connecting the leg members and providing support thereto. The outer shell 104 unitarily extends from an upper portion 108 to a lower portion 110. The lower portion 110 includes a size and shape disposable around, and attachable with (see FIG. 2), an outer perimeter portion of the inner base frame 102. When the lower portion 110 is attached to the inner base frame 102, the upper portion 108 of the outer shell 104 extends above the first loadable surface 106 and includes a second loadable surface 112.

To allow for attachment between the inner base frame 102 and the outer shell 104, a perimeter of the outer shell lower portion 110 is greater than the outer perimeter of the inner base frame. In an example, this lower portion perimeter of the outer shell 104 tapers to an upper portion perimeter, which is less in size than the outer perimeter of the inner base frame 102 thereby, providing a sleek and compact design. The upper portion 108 of the outer shell can include one or more substantially vertical arm members 118. In an example, the arm members 118 depend from the second loadable surface 112 and unitarily connect such surface and the outer shell lower portion 110. A stop member 120 can be provided on an inner surface 122 of the outer shell 104 to prohibit advancement of the shell over the inner base frame 102 past an acceptable attachment position. In an example, a portion of the stop member 120 contacts the first loadable surface 106 when the outer shell 104 is attached to the inner base frame 102. In the illustrative example of FIG. 1, the stop member 120 is in the form of a shoulder portion near a lower end of the arm members 118.

Material options for the step-stool assembly 100, and more specifically the inner base frame 102 and the outer shell 104, are various and can include metals, plastic resins, or rubbers, for example. In an example, the step-stool assembly 100 includes stainless steel. In another example, the step-stool assembly 100 includes a moldable or extrudable plastic resin, such as a thermoplastic of polyethylene, polypropylene, polystyrene, polyvinylchloride, or acrylonitrile-butadiene-styrene. In one such example, the plastic resin is dyed a desired end-use color, thereby negating the need to paint or otherwise finish the step-stool assembly 100 upon formation.

In some examples, the inner base frame 102 and the outer shell 104 are readily attachable with one another without the use of tools, such as by way of one or more complementary locking elements 124, 126. The interplay between the complementary locking elements 124, 126 can releasably secure the second loadable surface 112 above the first loadable surface 106. In an example, the one or more complementary locking elements 124, 126 include interlocking slots and ridges on opposing surfaces of the inner base frame 102 and the outer shell 104. In another example, the one or more complementary locking elements 124, 126 include a detent configured to snap into a mating recess. In some examples, the inner base frame 102 and the outer shell 104 are attachable with one another using one or more mechanical fasteners, such as screws.

After attachment, as shown in FIG. 2, both the first 106 and the second 112 loadable surfaces are sufficiently exposed to permit a user to step on such surfaces from a variety of directions, such as two, three, or four directions, surrounding the step-stool assembly 100. The first loadable surface 106, for example, is exposed substantially in its entirety via a plurality of foot-receiving apertures 202 in the outer shell 104.

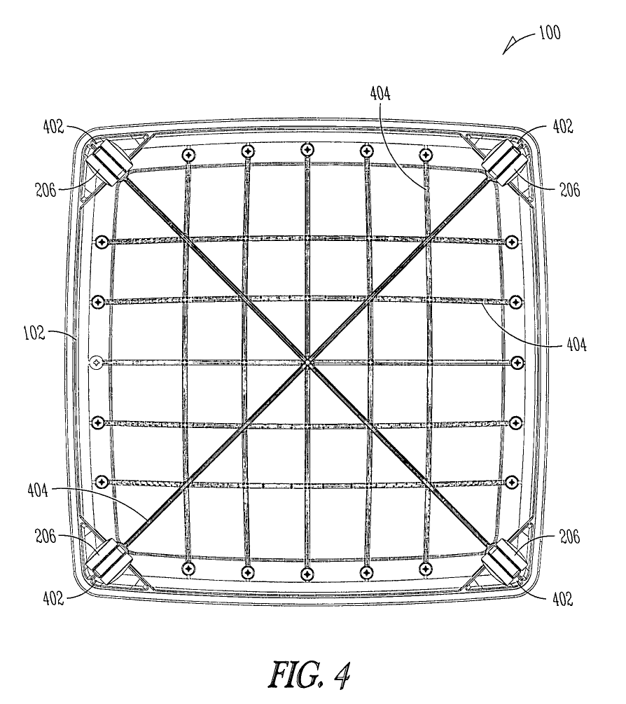

In operation, a user can kick or otherwise urge the step-stool assembly 100 to a location he/she desires via one or more roller units 204, at which time he/she can step on up or sit on down via the loadable surfaces 106, 112. In the example shown, the step-stool assembly 100 includes four roller units 204; however, the present assemblies are not limited thereto. Each roller unit 204 can include a spring-biased wheel member 206 mounted for reciprocal movement with respect to a mounting socket 402 (FIG. 4) fixedly secured to an interior of the inner base frame 102. A compression spring can be located around a swivel stem of the wheel member 206 in a position between a closed end of the socket 402 and the wheel member 206. Under no-load conditions, the roller units 204 are in their expanded configuration shown in FIG. 2 and rollably support the step-stool assembly 100 on the floor 210. In the expanded configuration, a bottom edge 208 of the outer shell 104 is located in a spaced relationship to the floor 210.

When load is applied to the first 106 or second 112 loadable surfaces of the step-stool assembly 100, the roller units 204 are compressed against the action of the compression springs to a collapsed condition in which the bottom edge 208 of the outer shell 104 is no longer spaced from the floor 210. In the collapsed condition, the swivel stem of the wheel member 206 retracts within the socket 402. In various examples, a floor engagement member 212, such as a bumper, is disposed adjacent the bottom edge 208 and contacts the floor when the roller units 204 assume their collapsed condition (see FIG. 5), thereby stabilizing the step-stool assembly 100 in a stationary position as the user steps on up or sits on down.

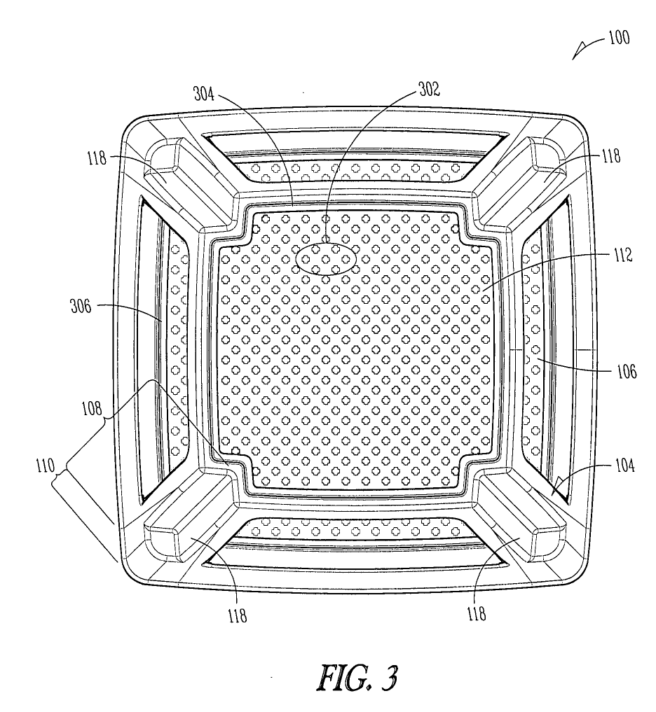

FIG. 3 illustrates a top view of a step-stool assembly 100. As shown, the first loadable surface 106 can include a greater area than an area of the second loadable surface 112. As also shown, the arm members 118 linking the upper 108 and lower 110 portions of the outer shell 104 can be equally spaced around the assembly 100. In an example, an arm member 118 depends from each corner of the second loadable surface 112. The outer shell 104 can be tapered inwardly from the lower portion 110 to the upper portion 108 for sleekness and compactness. To prevent slipping of a user as he/she steps on up or sits on down, one or more non-slip members 302 can be disposed on at least one of the first 106 or second 112 loadable surfaces. As shown, the non-slip members 302 can be nested within a ridge 304, 306 surrounding the loadable surfaces 106, 112. In an example, the non-slip members 302 include a ribbed design molded in the loadable surfaces 106, 112. The non-slip members 302 can also simply be a coating, such as a porous rubber or a pumice-impregnated friction layer attached to the loadable surfaces 106, 112.

FIG. 4 is a bottom view of a step-stool assembly 100. As shown, at least one of the first 106 (FIG. 1) or second 112 (FIG. 1) loadable surfaces can include a plurality of ribs 404 on an underside thereof to aid in support of a load placed thereon, such as a user standing or sitting on the surfaces. In an example, the plurality of ribs 404 are in the form of a repetitive honeycomb-like pattern. As also shown, a mounting socket 402 fixedly secured to an interior of the inner base frame 102 can retain the spring-biased wheel members 206 while permitting movement or collapsing of the same under load conditions. Optionally, one or more mechanical fasteners, such as screws, can be inserted from the underside of the inner base frame 102 into a portion of the outer shell 104 (FIG. 1) for secure coupling therebetween.

FIG. 5 is a cross-sectional view of a portion of a step-stool assembly 100, such as along line 5-5 of FIG. 2. As discussed above, the step-stool assembly 100 can include a floor engaging member 212 disposed around a perimeter of a lower portion 110 of an outer shell 104. In an example, the floor engaging member 212 is in the form of a bumper and is secured to the lower portion 110 by any suitable means, such as having an annular lip portion thereof retained by a shell recess. In an example, the floor engaging member 212 includes a vinyl or other resilient material extruded in a continuous ring.

The floor engaging member 212 is secured to the lower portion 110 of the outer shell 104 to provide a frictional engagement with the floor 210 in response to a downward load applied to the first 106 (FIG. 1) or second 112 (FIG. 1) loadable surfaces. This frictional engagement resists movement of the step-stool assembly 100 relative to the floor 210 as a user steps on up or sits on down the loadable surfaces 106, 112. When subjected to load, the roller units 204 (FIG. 2), which facilitate movement of the step-stool assembly 100 about the floor 210, retract into the inner base frame 102 (FIG. 1) to permit the floor engaging member 212 to contact the floor and minimize slippage when the assembly is in use. In an example, upon contact with the floor 210, the floor engaging member partially deforms 502 providing greater surface area contact and stability with the floor. In addition to stabilizing the step-stool assembly 100 relative to the floor 210, the floor engaging member 212 also provides marring and scratch protection to walls and other furniture as the assembly 100 is moved from a first location to a second location.

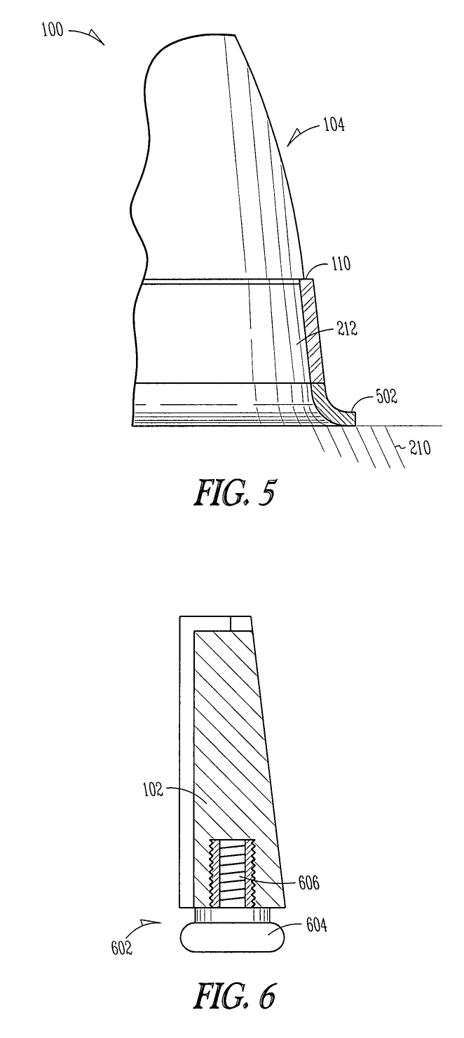

FIG. 6 illustrates a gliding member 602 for optional use with a step-stool assembly 100. The gliding member 602 can be used in addition to, or in lieu of, the roller units 204 (FIG. 2) to facilitate sliding movement of the step-stool assembly 100 from a first location to a second location. In an example, the gliding member 602 includes a glide surface portion 604 of a nonfrictional material, such as smooth plastic or metal. In an example, a stem portion 606 of the gliding member 602 is coupled to the inner base frame 102 via one or more threads.

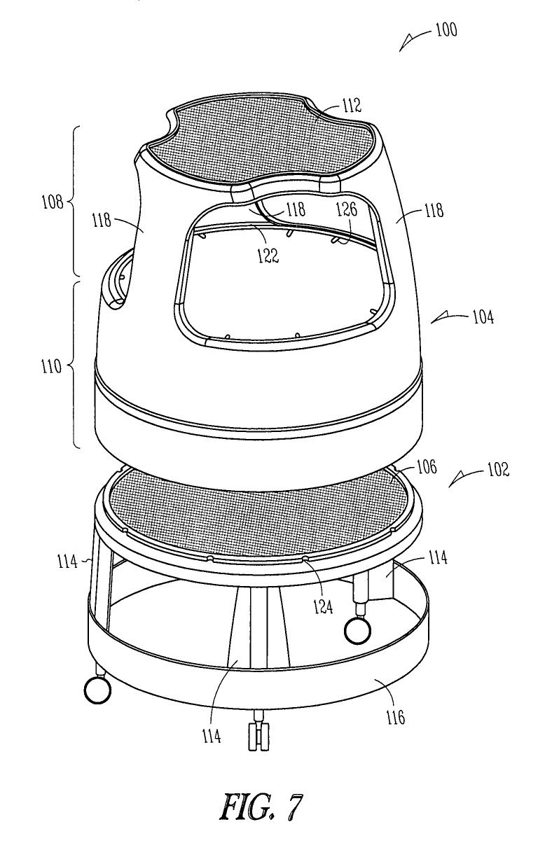

Although the majority of this patent document has shown and described a square-like step-stool assembly 100, other configurations, such as rectangular, oval, or circular (as shown in FIG. 7) are also possible. The circular step-stool assembly 100 of FIG. 7, like the square-like assembly, includes an inner base frame 102 and a continuous outer shell 104. The inner base frame 102 of the circular assembly includes a first loadable surface 106 near a top portion thereof. In the example shown, the inner base frame 102 is substantially hollow with three leg members 114 depending from the first loadable surface 106 and having a circular lower rim 116 connecting the leg members and providing support thereto. The outer shell 104 unitarily extends from an upper portion 108 to a lower portion 110. The lower portion 110 includes a size and shape disposable around, and attachable with, an outer perimeter portion of the inner base frame 102. When the lower portion 110 is attached to the inner base frame 102, the upper portion 108 of the outer shell 104 extends above the first loadable surface 106 and includes a second loadable surface 112.

To allow for attachment between the inner base frame 102 and the outer shell 104, a perimeter of the outer shell lower portion 110 is greater than the outer perimeter of inner base frame. In an example, this lower portion perimeter of the outer shell 104 tapers to an upper portion perimeter, which is less in size than the outer perimeter of the inner base frame 102 thereby, providing a compact and sleek conical-like design. The upper portion 108 of the outer shell can include one or more substantially vertical arm members 118. In an example, the arm members 118 depend from the second loadable surface 112 and unitarily connect such surface and the outer shell lower portion 110. A stop member 120 can be provided on an inner surface 122 of the outer shell 104 to prohibit advancement of the shell over the inner base frame 102 past an acceptable attachment position. In an example, a portion of the stop member 120 contacts the first loadable surface 106 when the outer shell 104 is attached to the inner base frame 102. In the illustrative example of FIG. 1, the stop member 120 is in the form of a linear projection.

In some examples, the inner base frame 102 and the outer shell 104 are readily attachable with one another without the use of tools, such as by way of one or more complementary locking elements 124, 126. The interplay between the complementary locking elements 124, 126 can releasably secure the second loadable surface 112 above the first loadable surface 106. In an example, the one or more complementary locking elements 124, 126 include interlocking slots and ridges on opposing surfaces of the inner base frame 102 and the outer shell 104. In some examples, the inner base frame 102 and the outer shell 104 are attachable with one another using one or more mechanical fasteners, such as screws.

After attachment, both the first 106 and the second 112 loadable surfaces are sufficiently exposed to permit a user to step on such surfaces from a variety of directions, such as two, three, or four directions, surrounding the step-stool assembly 100. The first loadable surface 106, for example, is exposed substantially in its entirety via a plurality of foot-receiving apertures 202 in the outer shell 104.

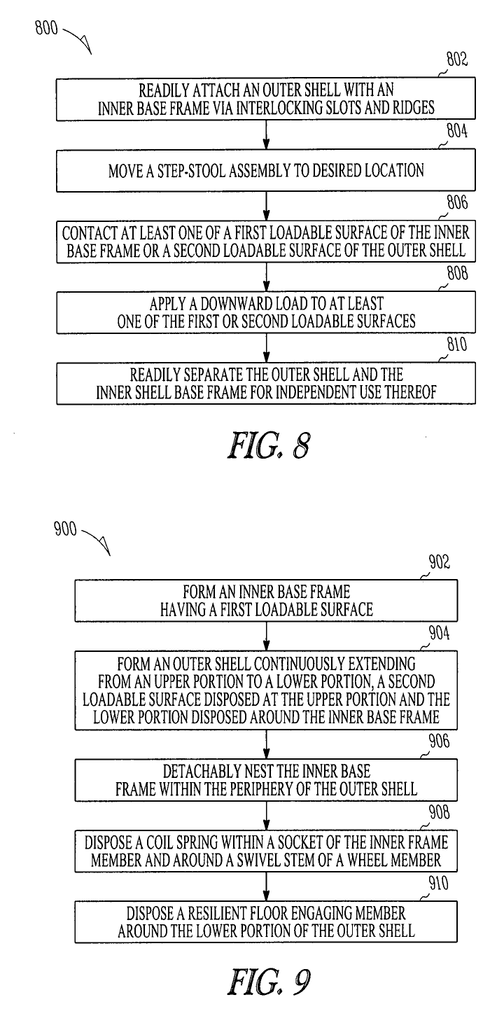

FIG. 8 is a block diagram of an example method 800 of using a step-stool assembly including an inner base frame and a continuous outer shell. At 802, the outer shell is readily attached to the inner base frame via one or more complementary locking elements, such as mating slots and ridges. Optionally, one or more mechanical fasteners can provide further coupling between the inner base frame and the continuous outer shell. At 804, the step-stool assembly is moved to a desired location. Under no-load conditions, the step-stool assembly can be moved to the location desired by merely applying a force to the outer shell. In an example, one or more roller units coupled with the inner base frame aid in the movement of the step-stool assembly. In an example, one or more gliding members coupled with the inner base frame aid in the movement of the step-stool assembly.

At 806, at least one of a first loadable surface of the inner base frame or a second loadable surface of the outer shell is contacted. The outer shell unitarily extends from an upper portion including the second loadable surface to a lower portion disposable around the inner base frame. In various examples, the first loadable surface is contacted via at least one foot-receiving aperture in the outer shell. In such an example, the first loadable surface is contacted by intersecting two arm members linking the upper and lower portions of the outer shell.

At 808, a downward load is applied to at least one of the first or second loadable surfaces, such as when a user steps on up or sits on down the assembly. The application of load to the first or second loadable surfaces causes a retraction of one or more roller units within the inner base frame and subsequently, contact between a floor engaging member disposed around the lower portion of the outer shell and a floor surface. This frictional contact between the floor engaging member and the floor surface resists movement of the step-stool assembly relative to the floor as the user steps on up or sits on down. At 810, the outer shell and the inner base frame are readily separated, such as without the use of tools, for desired independent use thereof.

FIG. 9 is a block diagram of an example method 900 of manufacturing a step-stool assembly including an inner base frame and an outer shell. At 902, an inner base frame having a first loadable surface near a top portion thereof is formed. At 904, an outer shell continuously extending from an upper portion to a lower portion is formed. Forming of the outer shell includes disposing a second loadable surface at the upper portion and configuring the lower portion to be disposable around the inner base frame. In an example, forming the lower portion of the outer shell includes forming at least one side wall depending from an end of an arm member linking the upper and lower shell portions. In various examples, forming at least one of the inner base frame or the outer shell includes injection molding a polymer resin material.

At 906, the inner base frame is detachably nested within the periphery of the outer shell. In an example, detachably nesting the inner base frame within the outer shell includes abutting a stop member protruding from an inner surface of the outer shell against a portion of the first loadable surface. In an example, detachably nesting the inner base frame within the periphery of the outer shell includes interlocking elements disposed on opposing surfaces of the inner base frame and outer shell. Optionally, one or more mechanical fasteners, such as screws, are used to further secure the inner base frame and the outer shell to one another.

At 908, a coil spring is disposed around a swivel stem of a wheel member and within a socking of the inner frame member. A first end of the coil spring can be configured to rest against a closed end of the socket, while a second end of the coil can be engaged with the wheel member to bias the wheel member outward. This outward bias of the wheel member allows for rollable support of the step-stool assembly on a floor. At 910, a resilient floor engaging member is disposed around the lower portion of the outer shell. Among other things, the resilient floor engaging member provides frictional engagement with the floor in response to a downward load applied to at least one of the first or second loadable surfaces. This frictional engagement resists movement of the step-stool assembly relative to the floor as a user steps on up or sits on down.

Conclusion:

Step-stool assemblies that are sturdy in construction, structurally efficient in providing support to a user, relatively lightweight, sleek and compact, simple to assembly and disassemble—in some examples without the use of tools, and economical to manufacture are provided herein. The step-stool assemblies include an inner base frame and a continuous outer shell. The inner base frame includes a first loadable surface near a top portion thereof. The outer shell unitarily extends from an upper portion to a lower portion. The lower portion includes a size and shape disposable around, and attachable with, an outer perimeter portion of the inner base frame. The upper portion is configured to extend above the first loadable surface of the base frame when the outer shell and inner base frame are attached, and includes a second loadable surface. The outer shell includes at least one foot-receiving aperture to provide attached access to the first loadable surface.

Closing Notes:

The above Detailed Description includes references to the accompanying drawings, which form a part of the Detailed Description. The drawings show, by way of illustration, specific embodiments in which the invention can be practiced. Notably, however, the invention may be designed differently to suit different applications. For instance, the present step-stool assemblies can be practiced with a larger or lesser number of loadable surfaces. These embodiments are also referred to herein as “examples.” All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated.

In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more features thereof) may be used in combination with each other. Other embodiments can be used, such as by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

The Abstract is provided to comply with 37 C.F.R. §1.72(b), to allow the reader to quickly ascertain the nature of the technical disclosure. It is submitted with the understanding that it will not be used to interpret or limit the scope or meaning of the claims.

What is claimed is:

1. A step-stool assembly comprising:
an inner base frame having a first loadable surface near a top portion thereof, and
a continuous outer shell having an upper portion and a lower portion, the lower portion having a size and shape disposable around, and attachable with, an outer perimeter portion of the inner base frame, the upper portion extending above the first loadable surface and including a second loadable surface,
wherein the first loadable surface is accessible via at least one foot-receiving aperture in the outer shell when the inner base frame is attached with the outer shell.

2. The step-stool assembly of claim 1, wherein a perimeter of the lower portion of the outer shell is greater than the outer perimeter of the inner base frame, and a perimeter of the upper portion of the outer shell is less than the outer perimeter of the inner base frame.

3. The step-stool assembly of claim 1, wherein the first loadable surface is exposed substantially in its entirety via the at least one foot-receiving aperture.

4. The step-stool assembly of claim 1, wherein the upper portion of the outer shell includes one or more substantially vertical arm members, the arm members linking the second loadable surface and the lower portion of the outer shell.

5. The step-stool assembly of claim 1, comprising a stop member provided on an inner surface of the outer shell, a portion of the stop member contacting the inner base frame when the outer shell is attached therewith.

6. The step-stool assembly of claim 1, comprising one or more retractable roller units, each roller unit coupled with a portion of the inner base frame and providing rollable support to no-load conditions and collapsible under application of load to the first or second loadable surfaces.

7. The step-stool assembly of claim 6, wherein a stem portion of the one or more retractable roller units is configured to retract within an inner base frame socket under application of the load.

8. The step-stool assembly of claim 1, comprising one or more non-slip members disposed on at least one of the first or second loadable surfaces.

9. The step-stool assembly of claim 1, comprising a floor engaging member disposed around a perimeter of the lower portion of the outer shell.

10. The step-stool assembly of claim 1, wherein the inner base frame and the outer shell are attachable with one another using one or more complementary locking elements.

11. The step-stool assembly of claim 1, wherein the first loadable surface is exposed from a plurality of directions via the at least one foot-receiving aperture.

12. The step-stool assembly of claim 1, wherein the inner base frame is substantially hollow with leg members depending from the first loadable surface and having a lower rim connecting the leg members providing support thereto.

13. The step-stool assembly of claim 1, wherein at least one of the first or second loadable surfaces includes a plurality of ribs configured to support a load applied thereto.

14. A method comprising:
moving a step-stool assembly to a desired location;
contacting at least one of a first loadable surface of an inner base frame or a second loadable surface of an outer shell, the outer shell unitarily extending from an upper portion including the second loadable surface to a lower portion disposable around the inner base frame, and including at least one foot-receiving aperture providing access to the first loadable surface; and
applying a downward load to at least one of the first or second loadable surfaces, including retracting one or more roller units and contacting a floor engaging member disposed around the lower portion of the outer shell with a floor surface.

15. The method of claim 14, comprising attaching the outer shell with the inner base frame via, at least in part, interlocking slots and ridges on opposing inner base frame and outer shell surfaces.

16. The method of claim 14, comprising readily separating the outer shell and the inner base frame for independent use thereof.

17. The method of claim 14, wherein contacting the first loadable surface includes intersecting two arm members linking the upper and lower portions of the outer shell.

18. A method comprising:
forming a first loadable surface and a second loadable surface at different height elevations, including
forming an inner base frame having the first loadable surface near a top portion thereof;
forming an outer shell continuously extending from an upper portion to a lower portion, the second loadable surface disposed at the upper portion and the lower portion disposable around the inner base frame; and
detachably nesting the inner base frame within the periphery of the outer shell.

19. The method of claim 18, wherein forming the lower portion of the outer shell includes forming at least one side wall depending from an end of an arm member linking the upper and lower shell portions.

20. The method of claim 18, wherein forming the lower portion of the outer shell includes forming a shell perimeter greater than an outer perimeter of the inner base frame.

21. The method of claim 18, comprising disposing a coil spring within a socket of the inner frame member, the coil spring configured to rest against a closed end of the socket on a first end and engage with a wheel member on a second end.

22. The method of claim 18, comprising disposing a resilient floor engaging member around the lower portion of the outer shell.

23. The method of claim 18, wherein detachably nesting the inner base frame within the outer shell includes abutting a stop member protruding from an inner surface of the outer shell against a portion of the first loadable surface.

24. The method of claim 18, wherein detachably nesting the inner base frame within the periphery of the outer shell includes interlocking elements disposed on opposing surfaces of the inner base frame and outer shell.

25. The method of claim 18, wherein forming at least one of the inner base frame or the outer shell includes molding a polymer resin material.
